(19) United States
(12) Patent Application Publication
(10) Pub. No.: US 2009/0307183 A1
(43) Pub. Date: Dec. 10, 2009

(54) System and Method for Transmission of Communications by Unique Definition Identifiers

(76) Inventor: Eric Arno Vigen, Laguna Hills, CA (US)

Correspondence Address: Eric Arno Vigen, 4845 Rubio Avenue, Encino, CA, 91436-1118, US

(21) Appl. No.: 12/136,731

(22) Filed: Jun. 10, 2008

(51) Int. Cl. G06F 17/22; G06F 17/30

(52) U.S. Cl. 707/1; 707/E17.001

(57) ABSTRACT

A system and method are provided for transmitting communications according to unique definition identifiers associated with the underlying elements (e.g., words) of the communications. The unique defintion identifiers are unique identifiers associated with a specific defintion, such as a unique numerical code of a certain length. Rather than storing, analyzing and transmitting the particular words that make up a communication, the communication is transmitted by a set of unique definition identifiers in accordance with the present system and method.

### RELATED APPLICATIONS

This application is related to the following applications, all of which are incorporated by reference herein in their entirety:

U.S. patent application Ser. No. 11/303,304, entitled, “System and Method for Analyzing Communications Using Multi-Dimensional Hierarchical Structures,” filed Dec. 16, 2005 by the present inventor;

U.S. patent application Ser. No. 11/512,807, entitled, “System and Method for Analyzing Communications Using Multi-Dimensional Hierarchical Structures,” filed Aug. 29, 2006 by the present inventor; and

U.S. patent application Ser. No. 12/012,753, entitled, “System and Method for Analyzing Communications Using Multi-Placement Hierarchical structures,” filed Feb. 5, 2008 by the present inventor.

### BACKGROUND

This disclosure relates generally to the field of transmitting text and other communications along with its analysis and transformation for transmissions and presentations and, more particularly, to a system and method for transmitting communications by unique definition identifiers associated with the underlying elements of the communications along with their analysis and transformation for transmission and presentation.

Ambiguities often exist with respect to communications that are received by a receiving party due to the multiple meanings that are often associated with words and/or grammar in the underlying communication. Words and combinations of words in a communication can often possess multiple different meanings which may or may not be resolved depending upon the context in which they are used, where the creator of the communication has only one intended meaning for such words. By way of example, for simplicity, certain words may have on average more than two meanings. In order to understand the specific intending meaning of a communication, it is required to discern at least a combination of the individual meanings of the words sent in the communication. If a communication only includes two words with each word having have two possible meanings, then the potential combination set of meanings for those meanings is equal to four or 2². For even a simple one-paragraph email communication with 30 words, the potential combination set of meanings for those meanings is equal to 2³⁰ or over one billion potential combined meanings.

The difficulties associated with original communications containing many elements having multiple meanings are accentuated when translating such a communication from one format to another format (e.g., one language to another language or from a document compatible with one type of system to a document compatible with another type of system), thereby adding further ambiguity into the communication.

Existing methods for Internet web page search requests transmit words which are used to search multiple ‘ambiguous’ search locations so that the search captures results for multiple definitions of each word. Many search engines in fact embrace the ambiguous nature of the search by expanding the results table to include all results from multiple definitions of each word. Even in an Internet search using a few simple words, the set of traditional words sent in the communication stream to the search server generates ambiguous meanings which leads to hundreds, thousands and even millions of extra useless results. Even in basic communications, the recipient must reinterpret each word and hope to understand the sender's intended meaning of words or combined sets of words. Every day billions of communications in emails, in websites created and posted, in documents translated, even in patents filed, continue to flow in which ambiguities exist with respect to a person reading and interpreting such communications. Because of the ambiguities associated with multiple meanings of words, ambiguities are present in text-based searches (e.g., web page search requests), word processing error checking applications (e.g., grammar and spelling check features), and in foreign language translation applications. Current methods of transmitting communications transmit the communications as a combination of words, letters and/or grammar, such that the ambiguities inherently present in the words and grammar are continued to be transmitted and stored for all future uses of such communications.

Further, existing methods of transmitting electronic text in common electronic program usage involves representing each letter, space or element of punctuation as an eight-bit ASCII character in letter-based languages. Thus, each word is represented by a multiple of eight-bit ASCII characters based on the number of letters in the word, thereby occupying a large of amount of storage space to store electronic versions of communications or requiring a large amount of data to be transmitted in order to transmit the electronic communications from one location to another.

The transmission of a communication is not always letter-by-letter in an ASCII format. Other existing methods for transmission of electronic text for certain foreign languages, like Japanese and Chinese, utilize pictograms or symbols to re-create such pictograms. However, those pictograms or methods to represent words as pictograms still just words with multiple meanings and not a unique meaning definition. For example, ‘wishewah’ in Japanese can have a definition both as a physical ‘white shirt’ or ‘a professional person.’ In that sense, the present invention particularly improves the transmission of those foreign languages as well.

### SUMMARY

According to one or more embodiments, a system and method are provided for transmitting communications according to unique definition identifiers associated with the meaning of underlying elements (e.g., words) of the communications. The unique definition identifiers are unique identifiers associated with a specific definition, where such unique definition identifiers may comprise a unique numerical code of a certain length. Rather than transmitting the particular words, punctuation and grammar that make up a communication, the communication is transmitted by a set of unique definition identifiers in accordance with the present system and method to ensure that the meaning of communication is precisely known.

The definitions and meanings of the words in a received communication are initially determined using any of a variety of possible known techniques. The present system and method then associates unique definition identifiers with the determined meanings and only transmits the communication as the set of unique definition identifiers. By associating unique unique definition identifiers for all words in a communication, the present system and method eliminates disambiguities in the communication for all possible future uses of the communication. Further, the amount of information to be transmitted, stored and processed is greatly reduced by replacing previously-known letter-by-letter storage techniques for each word with only a unique definition identifier for each word selected from a universal core table of definition identifiers.

In this manner in one or more embodiments, a communication transmitted is only represented by its specific set of unique definition identifiers. In one aspect, by transmitting communications according to the unique definition identifiers corresponding to the underlying elements of the communications, the exact meaning of a communication can be stored and/or transmitted without the inherent ambiguities that can exist from different possible meanings that can be associated with the same word or same elements of grammar. This can be useful in generating exact translations of a communication from one language to another language. The present system and method can further be utilized for searching electronic documents (e.g., Internet searches), so that instead of performing text-based searching that can generate numerous ambiguous results that may be irrelevant to the desired search, unique definition identifiers can be utilized for the search request and matched with the same unique definition identifiers contained in documents stored in electronic documents (e.g., web pages) to only retrieve search results that exactly match the meaning of the search request.

In one or more embodiments, the grammar, emphasis, voice tone or other elements of communication can be further be represented the same format for the unique definition identifiers. The use of unique definition identifiers further allows the communications to be reconstructed and presented differently at different receiving locations, based on the attributes, preferences or circumstances of the different receiving locations (e.g., language, dialect, culture, etc.).

For purposes of summarizing the disclosure and the advantages achieved over the prior art, certain advantages of the disclosure may be described herein. Of course, it is to be understood that not necessarily all such advantages may be achieved in accordance with any particular embodiment of the disclosure. Those skilled in the art will recognize that the disclosure may be embodied or carried out in a manner that achieves or optimizes one advantage or group of advantages as taught herein without necessarily achieving other advantages as may be taught or suggested herein.

All of these embodiments are intended to be within the scope of the disclosure herein disclosed. These and other embodiments of the present disclosure will become readily apparent to those skilled in the art from the following detailed description of the preferred embodiments having reference to the attached figures, the disclosure not being limited to any particular preferred embodiment disclosed.

### DRAWINGS

The above-mentioned features and objects of the present disclosure will become more apparent with reference to the following description taken in conjunction with the accompanying drawings wherein like reference numerals denote like elements and in which:

FIG. 1 is an example block diagram illustrating the conversion of a communication into a set of unique definition identifiers associated with the underlying communication elements of the communication in accordance with one or more embodiments of the present disclosure.

FIG. 2 is an operational flow diagram showing a method for converting a communication into a set of unique definition identifiers associated with the underlying communication elements of the communication in accordance with one or more embodiments of the present disclosure.

FIG. 3 is an operational flow diagram showing a method for converting a communication into a set of unique definition identifiers associated with the underlying communication elements of the communication in accordance with one or more embodiments of the present disclosure.

FIG. 4 is an operational flow diagram showing a method for transmitting a communication as a set of unique definition identifiers and reconstructing the communication into the underlying communication elements of the communication in accordance with one or more embodiments of the present disclosure.

FIG. 5 is a block schematic diagram of an exemplary computer system that may be utilized for implementing the storing, analyzing and transmitting of communications according to unique definition identifiers associated with the underlying communication elements of a communications in accordance with one or more embodiments of the present disclosure.

FIG. 6 is a block schematic diagram of an exemplary networked system that may be utilized for implementing the storing, analyzing and transmitting of communications according to unique definition identifiers associated with the underlying communication elements of a communications in accordance with one or more embodiments of the present disclosure.

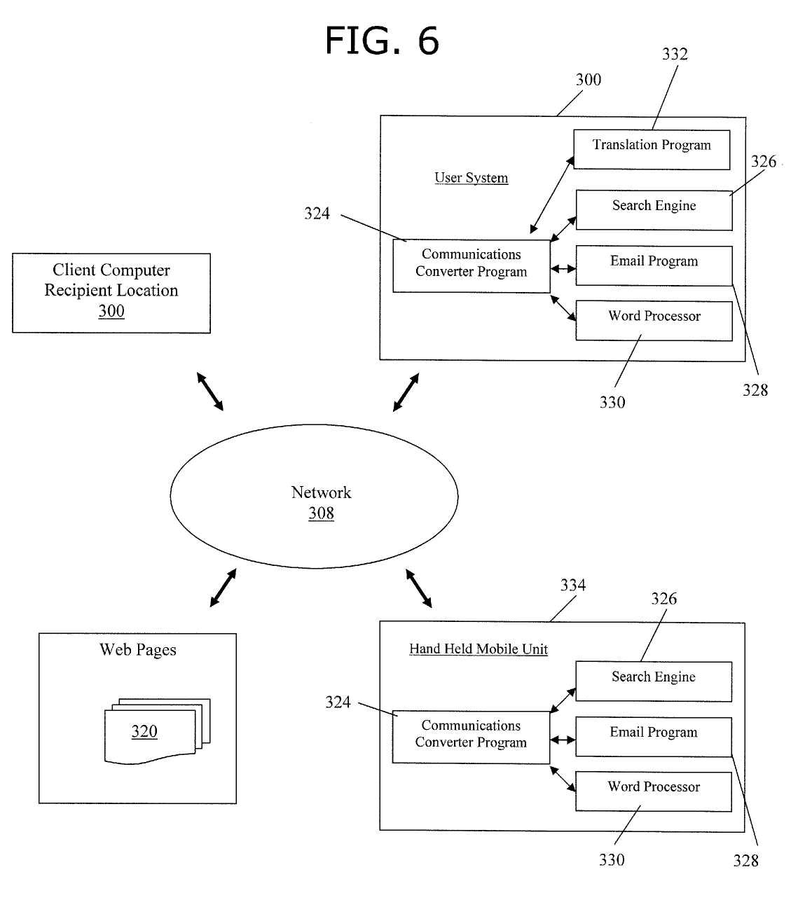

### DETAILED DESCRIPTION

In one or more embodiments, a novel system and method are provided for transmitting communications according to unique definition identifiers associated with the underlying communication elements of the communications. The unique definition identifiers are unique identifiers associated with a specific definition, where such unique definition identifiers may comprise a unique numerical code of a certain length. The terms definition identifiers and definition identifiers may be used interchangeably through the present disclosure. Rather than transmitting the particular communication elements (e.g., words, grammar, rules, etc.) that make up a communication, the communication is transmitted by a set of unique definition identifiers in accordance with the present system and method.

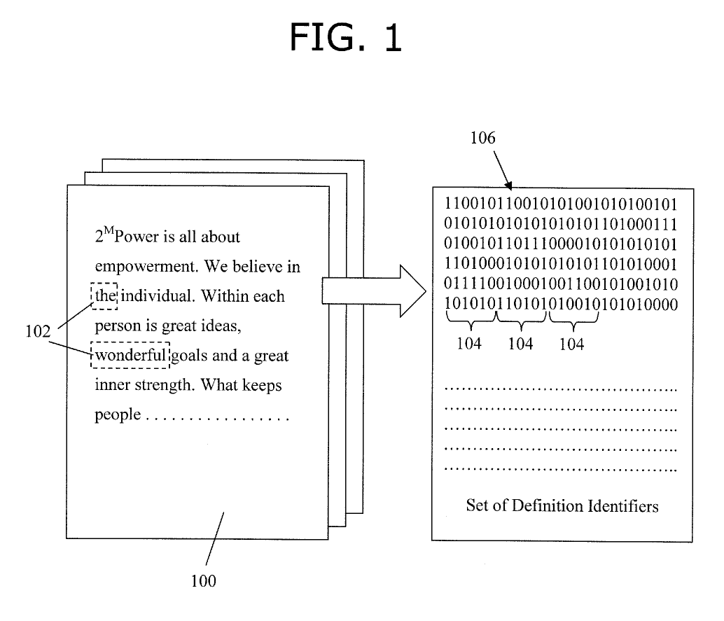

Referring now to FIG. 1, a block diagram is illustrated for one embodiment of the present method and system for transmitting communications according to unique definition identifiers associated with the underlying communication elements of the communications. Initially, a communication 100 containing communication elements 102 is received or otherwise obtained, retrieved or generated, where the communication 100 may be presented in any form (e.g., text, handwriting, digital text files, audio files, audio streaming, live speech, visual communication, etc.) and in any language. Based upon the form in which the communication 100 is received, some embodiments may require that the communication undergo an initial transformation to place the communication in a recognizable form capable of being parsed into the individual underlying communication elements 102 that make up the communication 100. For instance, a character recognition device may be utilized to convert written text or handwriting into a digital text files or a speech recognition device may be utilized to convert speech or audio files into digital text files as are known to those skilled in the art.

Each communication 100 comprises a plurality of underlying constituent communication elements 102, such as letters, words, punctuation, line breaks, paragraph breaks, page breaks, headings, text files, image files, sound files and such. The communication 100 may further include at least one and likely many communication groups, such as words alone, phrases, sentences, paragraphs, passages, chapters and such. After the received communication 100 is placed into a recognizable and parsable form, the received communication is separated or parsed into individual communication elements 102, such as words, groups of words, or punctuation. Individual communication elements will be described in the various embodiments as words for ease in describing the present system method, but it is understood that the communication elements 102 may take any form consistent with the teachings herein.

Each of the communication elements 102 are then respectively converted into respective definition identifiers 104, wherein each definition identifier 104 is uniquely associated with a definition for a corresponding communication element 102 or group of communication elements 102. All of the definition identifiers 104 for the communication elements 102 of the communication 100 are collectively assembled as a set of definition identifiers 106. This set of definition identifiers 106 then represents the communication 100 as a set of disambiguous definition identifiers 104, such that the communication can be transmitted to a recipient party in its disambiguous form.

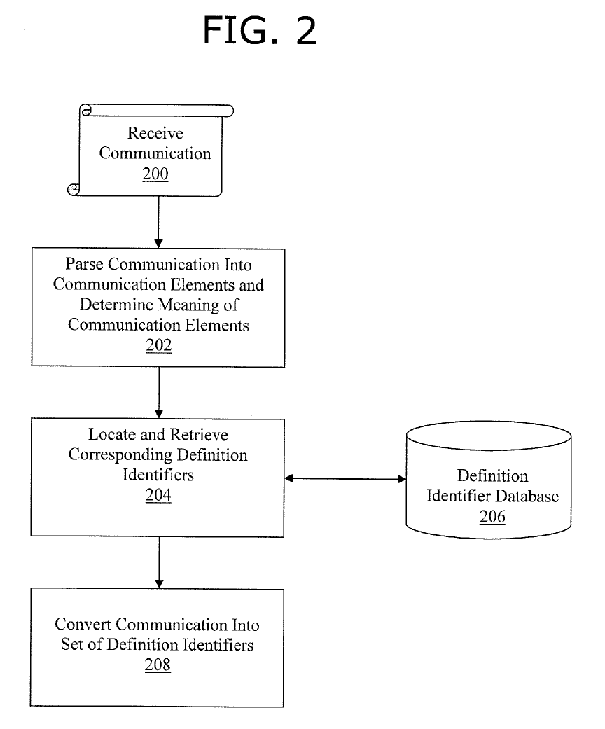

Referring now to FIG. 2, an operational flow diagram is illustrated for a process in which a communication 100 is converted into a set of definition identifiers 106 in accordance with one or more embodiments. A communication 100 containing communication elements 102 is received or otherwise obtained, retrieved or generated (200). The communication 100 is parsed into its constituent communication elements 102, and the meaning of the communication elements 102 is determined (202) using any such methods known to those skilled in the art for extracting meaning from a communication. For example, the present inventor has set forth systems and methods for analyzing communications to extract meaning from the communications in the following U.S. Patent Applications: U.S. patent application Ser. No. 11/303,304, entitled, “System and Method for Analyzing Communications Using Multi-Dimensional Hierarchical Structures,” filed Dec. 16, 2005; U.S. patent application Ser. No. 11/512,807, entitled, “System and Method for Analyzing Communications Using Multi-Dimensional Hierarchical Structures,” filed Aug. 29, 2006; and U.S. patent application Ser. No. 12/012,753, entitled, “System and Method for Analyzing Communications Using Multi-Placement Hierarchical structures,” filed Feb. 5, 2008, the contents of all of which are hereby incorporated by reference in their entireties.

Using the extracted meaning of the communication elements 102, corresponding definition identifiers 104 are located and retrieved (204) from an accessible definition identifier database 206. The definition identifier database 206 is a database or table containing definition identifiers 104 that are associated with corresponding definitions for respective communication elements 102. The unique definition identifiers 104 stored in the definition identifier database 206 are unique identifiers associated with a specific definition, such as a unique numerical code of a certain length as depicted in FIG. 1. Definition identifiers 104 may be associated with letters, words, groups of words, punctuation, line breaks, paragraph breaks, page breaks, headings, text files, image files, sound files or any communication elements 102 for which meaning can be attached. After retrieving (204) the appropriate definition identifiers 104 corresponding to the proper meaning for the communication elements 102, the communication 100 is converted (208) into a set 106 of definition identifiers 104. The converted communication can then be stored, analyzed and transmitted according to the set 106 of definition identifiers 104, rather than the conventional practice of storing, analyzing and transmitting the particular words that make up a communication.

By associating unique definition identifiers 104 for all words in a communication 100 and then transmitting the communication according to the set 106 of definition identifiers 104, the present system and method eliminate disambiguities in the communication that is transmitted for all possible future uses of the communication. Further, the amount of information to be transmitted, stored and processed is greatly reduced by replacing previously-known letter-by-letter storage techniques for each word with only a unique definition identifier 104 for each communication element 102 (i.e., word) selected from a universal core table of definition identifiers.

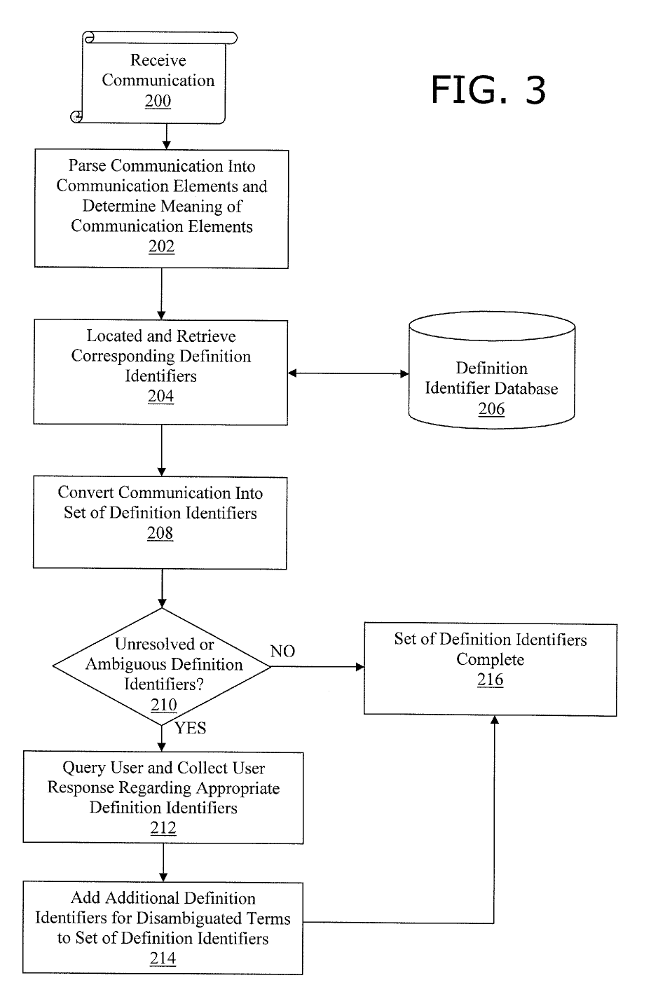

In one or more embodiments, unresolved or potentially ambiguous associations between definition identifiers 104 and communication elements can further be clarified, as illustrated in the operational flow diagram presented in FIG. 3. After the communication 100 is converted (208) into a set 106 of definition identifiers 104 using all known and disambiguous definition identifiers 104, a determination is made (210) whether any of the communication elements 102 remain unresolved into definition identifiers 104 or whether a potentially ambiguous association exists between a communication element 102 and at least one definition identifier 104 (e.g., multiple possible definition identifiers 104 could be selected for a communication element 102). If so, then a user is queried for further information and the user's response is collected and assessed (212) to determine the appropriate specific definition identifier 104 that should be selected for the unresolved or potentially ambiguous communication element 102. All newly-resolved additional definition identifiers 104 are added (214) to the set 106 of definition identifiers 104 until the conversion of the communication 100 in into the set 106 of definition identifiers 104 is complete (216). Further, if there were no unresolved or potentially ambiguous definition identifiers 104, then the conversion of the communication 100 in into the set 106 of definition identifiers 104 is complete (216).

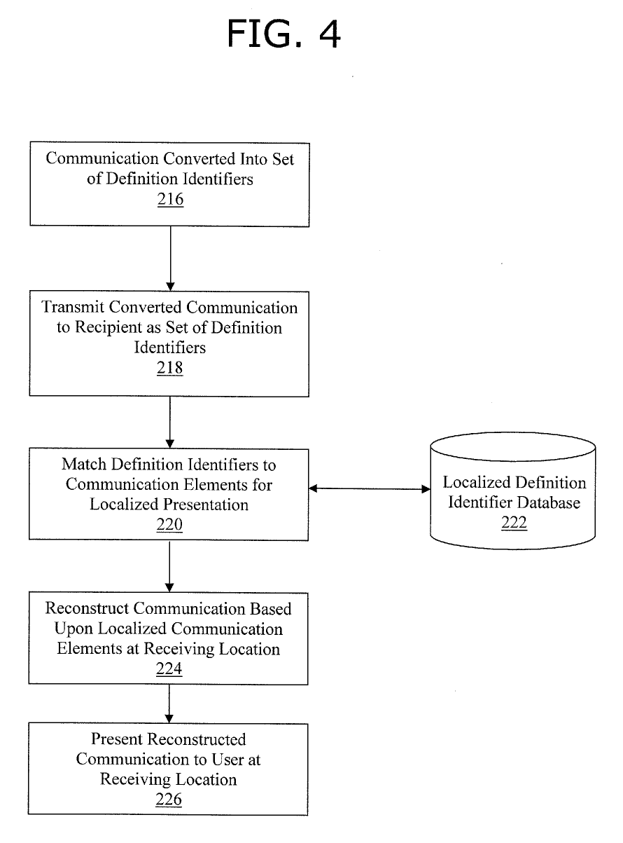

In one or more embodiments, a communication 100 that has been converted into a set 106 of definition identifiers 104 can be transmitted to a recipient at some location as the set 106 of definition identifiers 104, as illustrated in the operational flow diagram of FIG. 4. The communication 100 to be transmitted may either be received already in the format of a set 106 of definition identifiers 104 or the transmission may occur after the communication 100 has been converted into the set 106 of definition identifiers 104 in accordance with the conversion processes described in any of the embodiments described herein. The communication 100 is transmitted (218) to a recipient as a set 106 of definition identifiers 104. At the recipient location, a reverse procedure is performed in order to transform the definition identifiers 104 back into communication elements 102 for presentation to the recipient. The definition identifiers 104 are matched (220) against a localized definition identifier database 222 in order to retrieve the appropriate localized communication elements 102 that correspond to the received definition identifiers 104. Using the communication elements 102 retrieved from the localized definition identifier database 222, the communication 100 is reconstructed (224) and then presented (226) to a recipient or user at the recipient location or otherwise analyzed or stored at the recipient location.

In one or more embodiments, the localized definition identifier database 222 may include the same definition identifiers as the definition identifier database 206 but different respective communication elements 102. In this manner, the reconstructed communication 100 at the recipient location can be presented according to specific attributes, preferences or circumstances of the recipient location. Furthermore, different localized definition identifier databases 222 could possess different respective communication elements 102 that correspond to the same definition identifiers 104. For example, definition identifiers 104 could be converted into the communication elements “great color” in the USA while the same definition identifiers 104 could be converted into the communication elements “great colour” in the UK, based on the different presentation preferences of those different regions.

In one or more embodiments, the localized definition identifier database 222 may additionally contain localized display grammar, composition and order rules for presentation. For example, grammar, composition and order rules for presentation differ in different languages, such that the localized definition identifier database 222 can account for these differences such that the communication 100 is reconstructed at the recipient location to possess identical meaning as the transmitting location. In one or more embodiments, the explanation of the definitions identifiers 104 for a particular communication element 102 can also be displayed or presented to the recipient.

In this manner, a communication to be transmitted is only represented by its specific set of definition identifiers. In one aspect, by transmitting communications according to the unique definition identifiers corresponding to the underlying elements of the communications, the exact meaning of a communication can be stored and/or transmitted without the inherent ambiguities that can exist from different possible meanings that can be associated with the same word or same elements of grammar.

In one or more embodiments, communication elements 102 may include words, phrases, punctuation marks and inferred elements that are all converted into unique definition identifiers 104 in the communication 100 that is converted into a set 106 of definition identifiers 104 that subsequently can then be carried with communication 100 through storage, transmission, translation and/or any other possible future use of the communication 100. In one or more embodiments, the communication element 100 may include: (i) words or combinations of words, (ii) punctuation marks, and (iii) grammar, position and composition elements.

Words

Conventionally, there exist some words in various languages that can possess multiple different possible meanings, thereby sometimes resulting in ambiguity in understanding the meaning of a communication. For example, the word ‘throw’ has the meaning to “move a physical object” in the phrase “throw the ball.” However, the same word ‘throw’ can possess a different meaning of to “provide a fun event as the actor” in the phrase “throw a party.” When a word such as this possesses different meanings, there are ambiguities that inherently exist that can create problems when a recipient party of a communication is attempting to understand the communication or translate the communication. The present system and method resolve such ambiguities by replacing potentially ambiguous words with respective definition identifiers 104 having the exact meaning of the word as it is being used in a communication 100.

Punctuation Marks

Punctuation marks conventionally may also have multiple possible meanings which can make communications ambiguous. For example, a period text element has multiple definitions of (i) a mark indicating the end of a sentence, (ii) a mark indicating that a word has been abbreviated, and (iii) a mark indicating that both (i) and (ii) occurred. By way of example, the following sentence is referred to, “I ran in the Calif. triathlon race.” This example sentence has two periods with different meanings. The first period will often confuse conventional translation programs. However, in the present system and method, the definition identifiers would indicate that “Calif.” is not at the end of a sentence but instead an abbreviation for the following definition “the abbreviated form of California, a state of the USA.”

Similar ambiguities can results from the use of commas, where commas can mean: (i) opening of an appositive, (ii) closing of an appositive, (iii) separating elements with a group (‘and’ or ‘or), and (iv) showing the start of relative clause showing situation consequential to the situation describes at location of the comma.

Still further, ambiguities can exist when apostrophes are used with nouns, such that the apostrophe form of nouns can mean:

| Meaning | Example |
|---|---|
| Related to | America's promise |
| Belonging to | Chang's hat |

The present system and method resolve such ambiguities by replacing potentially ambiguous punctuation marks with respective definition identifiers 104 having the exact meaning of the punctuation marks as they are being used in a communication 100.

Example Definition Identifier Database Entry

By way of example, and without further limitation, the following description sets forth a representative example for the information that may be contained in the definition identifier database 206 or localized definition identifier database 222. For the sentence:

“He is finished as a Smallville politician”

The following table sets forth information which could be stored in the definition identifier databases 206 or 222:

| Traditional | Definition | |
|---|---|---|
| word/mark | identifier | Definition described in words |
| He | 010001001 | Relative pronoun presentation form to John |
| | | Q. Public, a specific person |
| is | 010001011 | A Knowledge verbs showing the |
| finished | 010001101 | A situation form (participle) that has the |
| | | result that the events ended. |
| in | 010011001 | inclusion within something abstract or |
| | | immaterial |
| Smallville's | 010011011 | Related to form for a location of Smallville, |
| | | USA |
| politics | 010011101 | the science or art of political government |
| | 100111010 | End of sentence marker |

In one or more embodiments, the communication “He is finished as a Smallville politician” would then be converted into the following set 106 of definition identifiers 104:

“010001001010001011010001101010011001010011011010011101100111010”

In one or more embodiments, the definition identifiers 104 could comprise a binary number of a certain length. In this manner, spaces in a communication would be unnecessary in that each identifier has the same length so the decoding system at the recipient location could be programmed to insert the appropriate spaces. In this manner, the communication 100 can occupy much less space for storage and transmission functions in its converted state comprising a set 106 of definition identifiers 104 by avoiding the convention practice of representing a word by a multiple of eight-bit ASCII characters based on the number of letters in the word and also representing spaces by ASCII characters. Further, the present system and method allow transmitted communications to be decoded and translated much faster into a foreign language because a large body of ambiguities have been eliminated through use of the definition identifiers 104.

In one or more embodiments, the definition identifiers 104 can further be utilized to specifically distinguish groups of words that would conventionally appear to be the same using only dictionary definitions but in reality possess different meanings. Along these same lines, groups of words in a communication may actually possess the same meaning as a different group of words, where this identical meaning would be lost if only conventional dictionary definitions were used to interpret the words.

By way of example, consider the word ‘work’ and the word ‘you’ in the following three example sentences:

1) “Work harder to succeed”

2) “You work harder to succeed.”

3) “You, work harder.”

‘Work’ in each of the example sentences falls into the same traditional dictionary definition. However, in one embodiment, each of these uses is different and uses a different definition identifier. The word “work” in the first sentence is an action verb that follows from a suppressed word ‘you.’ Without further information and investigation of the sentence, both the first and second sentence could use the same definition identifier for the word ‘work.”

However, upon further investigation of the sentences, the use of the word ‘you’ in each case is much different. The suppressed ‘you’ in the first sentence means “people in general.” The second sentence ‘you’ is a specific identifier that denotes the ‘you’ that is the party doing the action. The third sentence ‘you’ is an identifier of a specific party spoken to relative to the speaker. The third sentence ‘you’ is the recipient of a command, which is clearly not the same meaning of ‘you’ that exists in the first and second sentences. If the same definition identifier were utilized for both ‘work’ and “you’ in each of the sentences, the meaning of the sentences could be lost when converted and/or translated. To prevent this from occurring, the present system and method carries on the full definition and meaning of a communication by selecting appropriate definition identifiers that eliminates the need for the recipient end to ensure that the proper use of a communication element having multiple possible meanings was selected. The definition identifier itself has all the information that is required for such a determination, where the same also applies for grammar in the communication.

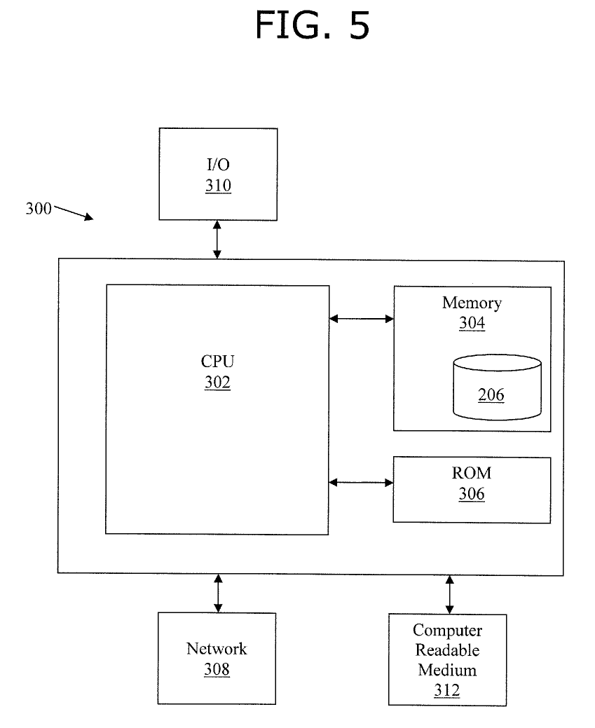

Referring now FIG. 5, an illustration of a general-purpose computer system 300 is provided which is suitable for implementing the system and method for analyzing and transmitting communications according to unique definition identifiers associated with the underlying communication elements of the communications in accordance with one or more embodiments of the present disclosure. The computer system 300 is only one example of a suitable computing environment and is not intended to suggest any limitation as to the scope of use or functionality of the invention. Neither should the computer system 300 be interpreted as having any dependency or requirement relating to any one or combination of components illustrated in the exemplary computer system 300.

In various embodiments, the present system and method for transmitting communications according to unique definition identifiers associated with the underlying communication elements of the communications is operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones, mobile wireless email devices (e.g., Blackberry®), multiprocessor systems, microprocessor-based systems, set top boxes, programmable consumer electronics, network PCs, minicomputers, mainframe computers, telephony systems, distributed computing environments that include any of the above systems or devices, and the like.

The present system and method for transmitting communications according to unique definition identifiers associated with the underlying communication elements of the communications may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. In one embodiment, the computer system 300 implements communications analysis by executing one or more computer programs. The computer programs are stored in a memory medium or storage medium such as the memory 304, ROM 306 and/or computer readable medium 312, or they may be provided to the CPU 302 through the network 308 or I/O bus 310.

The computer system 300 includes at least one central processing unit (CPU) or processor 302. The CPU 302 is coupled to a memory 304 and a read-only memory (ROM) 306. The memory 304 is representative of various types of possible memory: for example, hard disk storage, floppy disk storage, removable disk storage, or random access memory (RAM). As shown in FIG. 5, typically the memory 204 permits two-way access: it is readable and writable. The ROM 306 is typically readable only. The memory 304 and/or ROM 306 may store instructions and/or data which implement all or part of the functionality of the system and method described in detail herein, and the memory 304 and/or ROM 306 may be utilized to install the instructions and/or data. The definition identifier database 206 (and/or 222) may further be stored in memory 304 or remotely stored elsewhere and accessible by the computer system 300. Further, the converted set of definition identifiers may further be stored the memory 304 after conversion of a communication.

The computer system 200 may further include a variety of additional computer readable media 312. Computer readable media can be any available media that can be accessed by the computer system 300 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer system 300. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of any of the above should also be included within the scope of computer readable media.

The CPU 302 may be coupled to a network 308, such as a local area network (LAN), wide area network (WAN), or the Internet. The CPU 302 may acquire instructions and/or data for implementing communications analysis transformation over the network 308. Through an input/output bus 310, the CPU 302 may also coupled to one or more input/output devices that may include, but are not limited to, data storage devices, video monitors or other displays, track balls, mice, keyboards, microphones, touch-sensitive displays, magnetic or paper tape readers, tablets, styluses, voice recognizers, handwriting recognizers, printers, plotters, scanners, satellite dishes and any other devices for input and/or output. The CPU 302 may acquire communications, instructions and/or data to be processed through the input/output bus 310. It is further understood that the present system and method may alternatively be implemented using non-computer-related methods and systems.

In one or more embodiments, the system and method for transmitting communications according to unique definition identifiers associated with the underlying communication elements of the communications can be used in conjunction with search engine, email, word processing and/or translation functionalities.

Search Engine Functionality

Search engines are typically used to search for data in unstructured documents stored on Internet web pages that contain information that may or may not be formatted into any predefined manner. Such documents may include disparate information loosely arranged into paragraphs, lists, tables and other layouts. Unstructured documents may include web pages (e.g., Hypertext Markup Language (HTML) pages), web logs (blogs), Portable Document Format (PDF) documents, word processor documents, etc. In general, prior conventional keyword search engines have combed through unstructured documents and store keywords in a text index. The index record is associated with a network location and, often times, additional metadata about the document. When a user submits a keyword search, the search engine examines its records and returns the network locations of documents matching the keyword search. Some popular keyword search engines include Google® and AOL®. Google is a registered trademark of Google Incorporated and AOL is a registered trademark of AOL LLC Ltd. Liability Co. Prior conventional keyword search engines have only provided limited usefulness, because the results that are returned are ambiguated. For example, if a search term possesses multiple different meanings, then results associated with each of the multiple different meanings may be returned to a user.

Almost every word has multiple meanings, so even the simplest web search request using prior conventional keyword search engines would typically return false and unintended results based on such ambiguities of the meanings. In some instances, the false results would greatly outnumber the intended communications to be returned using prior conventional keyword search engines. The present system and method provide an effective solution to this problem by allowing web page search requests to be sent as a communication including only unambiguous definition identifiers, thereby allowing only results relevant to the unambiguous definition identifiers to be located and retrieved for a user. The search results could thus eliminate ½, ¾, ⅘ or even more of the meaningless results that have typically been returned using prior conventional keyword search engines that do not rely on the meaning of the search request.

In one or more embodiments, a client computer system 300 or a hand-held mobile unit 332 could include a communication converter program 324 that works in conjunction with a search engine 326, where the communication converter program 324 that performs the conversion between the communication elements 102 of search request communication and the corresponding definition identifiers 104 to be transmitted to various web pages 320. The search results including content from web pages 320 that are returned to a client computer system 300 can then be filtered to coincide with the meaning of the definition identifiers 104 included in the search request.

The communication converter program 324 thus works in conjunction with the search engine 326 to eliminate ambiguity in the search results by extracting meaning from the search request in an automated manner using the definition identifiers in place of the words of the search request. In this manner, the present system and method can eliminate ambiguity in the search request and the search results.

Email Functionality

In one or more embodiments, the system 300 could include the functionality of an email program 328 or the communication converter program 324 could otherwise be included within or connected to an email program 328 such that the emails received and/or sent by the email program could be converted into a set 106 of definition identifiers 104 in order to disambiguate the communicated emails. When an email is received by the intended recipient, the set 106 of definition identifiers 104 are reconstructed into words to be presented to the recipient party. In this manner, an identical email could be sent to multiple different parties who could speak different languages, such that the localized definition identifier database 222 at each of the recipient party locations could separately automatically reconstruct this same email into the corresponding language preferred by each recipient party while retaining the exact meaning of the original email. In one or more embodiments, the meaning associated with the definition identifiers can be stored along with the reconstructed communication so that a recipient party could select or ‘click on’ on word that the recipient party does not understand and the associated meaning can be provided to the recipient party.

Furthermore, as noted above, transmitting a communication solely using a set 106 of definition identifiers 104 can significantly reduce the size of an electronic file as opposed to sending an electronic file representing each and every letter, word and punctuation mark. In this manner, email communications can that are sent as a set 106 of definition identifiers 104 will occupy less bandwidth and could be transmitted more quickly in many circumstances.

Word Processing Functionality

In one or more embodiments, the system 300 could include the functionality of a word processing program 330 or the communication converter program 324 could otherwise be included within or connected to a word processing program 330 such that a document prepared by the word processing program 330 can be analyzed by the communication converter program 324 in order to store a document according to the meaning of the communication elements of the document by storing the document as a set 106 of definition identifiers 104. In one embodiment, the word processing program 330 could utilize the communication converter program 324 to prompt a user to clarify the meaning where a word when it is determined to be ambiguous based on the intended corresponding definition identifiers 104 for the word, where the word processing program 330 could even provide hints and recommendations to disambiguate the meaning. This clarification of the communication could be retained and used for more analysis and in transmission to others in a disambiguated format. In one or more embodiments, the meaning associated with a word in the communication could be obtained by a user by selecting or ‘clicking on’ on word in the communication that the user wants to understand its associated meaning.

Translation Functionality

In one or more embodiments, the system 300 could include the functionality of a translation program 330 or the communication converter program 324 could otherwise be included within or connected to a translation program 330 such that a document received by the system 300 can automatically be translated into a desired foreign language based on the corresponding communication elements 102 that are stored on the localized definition identification database 222.

In accordance with the various embodiments described herein, a system and method and provided that allow a communication to be transmitted by representing the communication elements of the communication as a corresponding specific set of unique definition identifiers. In one aspect, by transmitting communications according to the unique definition identifiers corresponding to the underlying elements of the communications, the exact meaning of a communication can be stored and/or transmitted without the inherent ambiguities that can exist from different possible meanings that can be associated with the same word or same elements of grammar. This can be useful in generating exact translations of a communication from one language to another language.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes and and all embodiments of the following claims.

1. A method comprising:
receiving a communication including a plurality of unique definition identifiers, where each unique definition identifier has only one universal unique definition that may be matched in a respective selected language to corresponding communication elements;
retrieving from a definition identifier database for each received unique definition identifier at least one corresponding communication element, wherein each unique definition identifier is uniquely associated with a corresponding communication element or group of communication elements; and
converting the communication from the plurality of unique definition identifiers into the corresponding retrieved communication elements.

2. The method of claim 1, further comprising presenting the converted communication as the retrieved communication elements to a user at the receiving location.

3. The method of claim 1, wherein the communications elements include at least one of a word, a set of words, a punctuation mark, letters, phonetic symbols, grammar rules and symbols representing words.

4. The method of claim 1, wherein each definition identifier possesses a unique definition, the method further comprising selecting communication elements to be retrieved based upon particular attributes or preferences at a location where the communication is received.

5. The method of claim 4, further comprising converting the same plurality of unique definition identifiers into different communication elements at different corresponding receiving locations where the communication is respectively received when the attributes or preferences are different at the different locations.

6. The method of claim 1, wherein the converted communication comprises a translation into corresponding communication elements of a desired language.

7. The method of claim 1, wherein the communication received is a document.

8. The method of claim 1, wherein the communication received is an email.

9. The method of claim 1, wherein the communication received comprises one of a website search request and website content.

10. The method of claim 1, wherein the communication received has been changed from its original form at a sending location to include the plurality of unique definition identifiers that are retrieved from a corresponding definition identifier database accessed at the sending location.

11. The method of claim 1, wherein the unique definition identifiers are binary numbers of a predefined length.

12. A method comprising:
transmitting a communication from a sending location to a receiving location as a plurality of unique definition identifiers,
each unique definition identifier having only one universal unique definition that may be matched in a respective selected language to corresponding communication elements, wherein each unique definition identifier is uniquely associated with a corresponding communication element or group of communication elements at the sending location and also uniquely associated with a corresponding communication element or group of communication elements at the receiving location.

13. The method of claim 12, wherein the communications elements include at least one of a word, a set of words, a punctuation mark, and a symbol.

14. The method of claim 12, wherein the communication transmitted is a document.

15. The method of claim 12, wherein the communication transmitted is an email.

16. The method of claim 12, wherein the communication transmitted comprises one of a website search request and website content.

17. The method of claim 12, further comprising initially converting the communication at the sending location from an original form of a plurality of communication elements into the plurality of unique definition identifiers by retrieving unique definition identifiers from a definition identifier database that uniquely correspond to corresponding communication elements in the communication.

18. The method of claim 12, wherein the unique definition identifiers are binary numbers of a predefined length.

19. A method, comprising:
receiving a communication including at least one communication element;
retrieving from a definition identifier database a unique definition identifier corresponding to each communication element received, where each unique definition identifier has only one universal unique definition that may be matched in a respective selected language to corresponding communication elements and wherein each unique definition identifier is uniquely associated with a corresponding communication element or group of communication elements; and
converting the communication from the received communication elements into a plurality of corresponding unique definition identifiers.

20. The method of claim 19, further comprising extracting a meaning of each communication element and utilizing the extracted meaning to identify the corresponding definition identifier to retrieve for each communication element.

21. The method of claim 19, further comprising storing the communication as solely as the plurality of corresponding unique definition identifiers.

22. The method of claim 19, further comprising transmitting the communication from a sending location to a receiving location as a set of unique definition identifiers.

23. The method of claim 22, further comprising transmitting additional information with the set of unique definition identifiers to the receiving location for use in reconstructing the definition identifiers into a set of communication elements for presentation at the receiving location.

24. The method of claim 22, further comprising:
retrieving from a definition identifier database at the receiving location for each received unique definition identifier a corresponding communication element, wherein each unique definition identifier is uniquely associated with a corresponding communication element or group of communication elements at the receiving location; and
converting the communication from the plurality of unique definition identifiers into the corresponding retrieved communication elements.

25. The method of claim 24, wherein at least one of the communication elements in the reconstructed communication located at the receiving location is different from the communication elements located at the sending location based upon attributes or preferences of the receiving location.

26. The method of claim 24, further comprising generating recommendations for modifying the communication elements in the reconstructed communication located at the receiving location based upon attributes or preferences of the receiving location.

27. The method of claim 19, wherein the communications elements include at least one of a word, a set of words, a punctuation mark, and a symbol.

28. The method of claim 19, wherein the communication transmitted is a document.

29. The method of claim 19, wherein the communication transmitted is an email.

30. The method of claim 19, wherein the communication transmitted comprises one of a website search request and website content.

31. The method of claim 19, wherein the definition identifiers are binary numbers of a predefined length.

32. The method of claim 19, further comprising:
when an ambiguity exists between a communication element and a corresponding unique definition identifier to be retrieved at the sending location, generating a query and analyzing a response to the query to resolve the ambiguity so that a single unique definition identifier is retrieved to correspond to such communication element.

33. The method of claim 19, further comprising:
determining if multiple unique definition identifiers exist with respect to a communication element in the definition identifier database;
if multiple unique definition identifiers exist, generating a query and analyzing a response to the query to assess which of the multiple definition identifiers should be retrieved with respect to such communication element.
